(19) United States
(12) Patent Application Publication
(10) Pub. No.: US 2012/0311629 A1
(43) Pub. Date: Dec. 6, 2012

(54) SYSTEM AND METHOD FOR ENHANCING AND EXTENDING VIDEO ADVERTISEMENTS

(75) Inventors: Eduard Zaslavsky, Issaquah, WA (US); Arthur Vaysman, San Jose, CA (US)

(73) Assignee: WebTuner, Corporation, Redmond, WA (US)

(21) Appl. No.: 13/490,338

(22) Filed: Jun. 6, 2012

Related U.S. Application Data
(60) Provisional application No. 61/493,619, filed on Jun. 6, 2011.

(51) Int. Cl. H04N 21/458

(52) U.S. Cl. 725/34

(57) ABSTRACT

Video advertisement with targeted and/or interactive and/or transaction enabled capabilities systems and methods are disclosed. The invention separates in time the transactional component of the video ad from the product or service message (e.g. commercial). By separating the transaction component of the video ad from the commercial, the viewer's experience as intended by the video ad creator is preserved. Additionally, the user experience is optimized for the transactional component by allowing the transactional component to take up extra real-estate on the video screen, allowing the viewer to focus on the transactional components without interfering with the commercial, and allowing the owner of the transactional component to add additional aspects, for example an audio track or moving elements, to improve the effectiveness of the transactional component.

### REFERENCE TO RELATED APPLICATIONS

This application claims priority to U.S. provisional Application Ser. No. 61/493619, filed Jun. 6, 2011, entitled “System and Method for Enhancing and Extending Video Advertisements with Targeted and/or Interactive and/or Transaction Enabled Capabilities,” which is hereby specifically and entirely incorporated by reference.

### BACKGROUND

1. Field of the Invention

The invention is directed to television advertisements. Specifically, the invention is directed to enhancing the effectiveness of television advertisements.

2. Background of the Invention

In existing television (TV) systems, advertisements (ads or commercials), including audio and/or video and/or interactive enhancements (for example Enhanced TV Binary Interchange Format (EBIF) applications), are injected at several points. Ads can be injected by, for example the national broadcasters (i.e. NBC or ABC), the programming networks (e.g. ESPN), the local programming network affiliates, the cable operators (or equivalent) with centralized ad injection at the head-end, the cable operators with targeted ads with distributed injection over switched digital video infrastructure, cable operators with targeted ads stored in Digital Video Recorders (DVRs) and injected into live or recorded streams, Video on Demand (VOD) operators, or Internet video streaming operators.

FIG. 1 depicts the main components and elements that are traditionally involved in the insertion, delivery, and playback of video ads as well as video ads enhanced by transactional components. Programmer 109 using national linear ad campaign management system 108 communicates with content schedules module 100 and national ads assets database 107, taking into considerations business rules and outstanding ad contracts to determine and produce an ad insertion schedule. Programmer 109 delivers the schedule to traffic system 101 through content schedules module 100. Automation system module 102 delivers the content and ad assets, which module 102 pulls from content assets module 103, national ads assets module 107, and metadata from traffic system 101, to digital compression system 104. Module 104 creates a multiplexed stream which usually comprises audio, video, and metadata information for both content and ads, and delivers the stream to uplink module 106.

Service provider 117 receives the multiplexed stream from Programmer 109 using downlink module 116 and receiver module 114. Ad splicer module 115 extracts metadata about the national ad spots and passes the metadata to linear ad insertion system 112 responsible for replacing national ads with local ads, which communicates with module 110. Module 110 takes business rules and contracts into consideration to instruct ad splicer 115 when to insert which ad from local ads assets module 113.

Ad splicer 115 creates a final multiplexed stream, comprising audio, video, and metadata information for both content and ads and delivers the stream to transport device module 111. The stream, in addition to video programming, may comprise national and local ads and correlated metadata. Module 111 delivers the stream to service node module 126. The final multiplex stream is then delivered to the client devices 128, 129, and 130 from edge QAMs (quadrature amplitude modulations) module 123 through HFC (hybrid fiber-coaxial) network 127. Client devices 128, 129, and 130 can also insert local ads stored in persistent storage module 131 or temporary storage module 132 using client ads management insertion system module 140. Each client device renders the final multiplex stream on a rendering device 135 for display to a viewer 136.

Television advertisements, initially created as passive nationally broadcasted video ads, are under pressure to compete with targeted and transaction enabled Internet ads. To meet the competitive challenge, some video ads are being enhanced with interactive capabilities which are usually implements as an afterthought overlay to already created video ads with an overlay displayed on top of the original video ad.

For example, FIG. 2 depicts an existing nationally inserted ad with interactive overlay 202. Usually, the ad 201 will start at time 205 and overlay will appear at time 206 (for example three seconds into the commercial). The overlay usually includes an interactive element 203. At time 207, the overlay disappears from the screen before, at time 208, the ad ends.

FIG. 3 depicts ad 301 which is the same ad as ad 201 as in FIG. 2. However, ad 301 is inserted locally. Ad 301 also includes interactive overlay 202. Usually, the ad 301 will start at time 205 and overlay will appear at time 206 (for example three seconds into the commercial). The overlay usually includes an interactive element 203. At time 207, the overlay disappears from the screen before, at time 208, the ad ends.

The interactive features are overlaid on existing advertisements because there is a global, unspoken agreement among TV video advertisers, ad creators, and ad distributors that TV video ads are expected to fit within a specific number of seconds in an ad segment. Since ad segments are historically measured in one minute increments, TV video ads are usually created as self-contained stories to fit within one minute, 30 seconds, 20 seconds, or 15 second spots. The industry believes that there is no room to ad pre- or post- roll elements and still fit all of the commercials into an allotted ad segment. In part, this practice has stood the test of time because all elements of the ad creation and distribution chain are currently being optimized around the abovementioned time segments. To add transactional capability to ads, the industry choose to implement generic, template based overlays to already created video ads, thus neglecting other more effective options.

Some problems of adding transactional overlays on top of already created video ads include: an impeded video ad user experience, a subpar user experience for the interactive overlay component, and higher viewer annoyance with afterthought overlays resulting in lower than possible response rates to and transaction rates with the display video ad. The user's experience may be impeded because the interactive component and video ad itself are created by different entities. The interactive component is typically created as a template based generic overlay with a “common denominator” designed to fit each and every ad. The generic overlay often cannot fit the look, feel, and spirit of each and every original video ad. Furthermore, usually, the generic overlay cannot be customized to fit the look, feel, and spirit of each and every video ad since video ads carry no metadata necessary to adjust the overlay color, shape, and location.

The user's experience may be subpar because the original video ad is created for a fully immersive and passive experience. However, the interactive overlay interrupts the experience by demanding active viewer participation which requires the viewer to shift focus from passive video consumption to active participation with the interactive overlay.

### SUMMARY OF THE INVENTION

The present invention overcomes the problems and disadvantages associated with current strategies and designs and provides new tools and methods of enhancing television advertisements.

One embodiment of the invention is directed to a transaction enabled video advertisement. The advertisement comprises a message component having a start time and an end time, and a transactional component having a start time and an end time, wherein the start time of the transactional component is after the end time of the message component.

In the preferred embodiment, the transactional component comprises at least one interactive element. Preferably, the duration of the transactional component is less than the duration of the message component. The transactional component is preferably an advertisement targeted to members of an audience. In the preferred embodiment, the advertisement is for display on at least one of a television, a computer, a tablet, a smart phone, a game console, a radio receiver, and a MP3 player.

Another embodiment of the invention is directed to a method of creating a video advertisement. The method comprises, on a processor, receiving a message component of the advertisement for presentation during an advertising break in programming, receiving a transactional component related to the message component, presenting the message component and the transactional component in separate time slots during the advertising break.

Preferably, the transactional component is not overlaid, superimposed, or displayed during the presentation of the message component. In the preferred embodiment, the transactional component comprises at least one interactive element. Preferably, duration of the transactional component is less than the duration of the message component. The message component is preferably created for passive consumption by an audience. Preferably, the transactional component is an advertisement targeted to members of an audience. The advertisement is preferably for display on at least one of a television, a computer, a tablet, a smart phone, a game console, a radio receiver, and a MP3 player.

Another embodiment of the invention is directed to a method of creating a video advertisement. The method comprises, on a processor, receiving a transmission of a program having an advertising segment, inserting a message component of the advertisement into the advertising segment of the program, and inserting a transactional component into the advertising segment of the program, wherein the message component and the transactional component are in separate positions within the advertising segment.

In the preferred embodiment, the transactional component is not overlaid, superimposed, or displayed during the presentation of the message component. Preferably, the transactional component comprises at least one interactive element. Preferably, the duration of the transactional component is less than the duration of the message component. The transactional component is preferably an advertisement targeted to members of an audience. Preferably, the advertisement is for display on at least one of a television, a computer, a tablet, a smart phone, a game console, a radio receiver, and a MP3 player.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 depicts the components involved in the insertion, delivery, and playback of video ads.

FIGS. 2-3 depict examples of existing transaction enabled video ads.

FIG. 4 depicts an embodiment of a transaction enabled video ad of the instant invention.

FIG. 5 depicts an embodiment of an advertising block including transaction enabled video ads of the instant invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

A problem in the art capable of being solved by the embodiments of the present invention is viewer's lower than possible response rate to transactional components (e.g. interactive overlays) of a video ad.

Transaction enabled video ads have two function parts, 1) a product or service message (message component) delivered as a video designed for viewers' passive consumption, and 2) a transactional component which allows for the viewers' to actively participate and respond to the advertisement. The transactional component is preferably interactive, allowing a viewer to choose to partake in the offered product or service. For example, the transactional component can be a button to purchase an item for sale or receive a coupon for a service, or a web-link directing a viewer to a web-site.

It has been surprisingly discovered that by separating in time the transactional component of the video ad from the product or service message (e.g. commercial), viewer response rate increases.

By separating the transaction component of the video ad from the commercial, the viewer's experience as intended by the video ad creator is preserved. Additionally, the user experience is optimized for the transactional component by allowing the transactional component to take up extra real-estate on the video screen, allowing the viewer to focus on the transactional components without interfering with the commercial, and allowing the owner of the transactional component to add additional aspects, for example an audio track or moving elements, to improve the effectiveness of the transactional component. Separation of the transaction component of the video ad from the commercial is achieved by using time segment (ad avail) pre-allocated to one of local ads for a number of targeted transaction segments added to one or several national and/or local ad spots.

Additionally, the instant invention preferably is capable of be implemented on existing video distribution networks (e.g. cable, satellite, IPTV, or broadband TV networks) where some video rendering devices can support transactional components while others cannot.

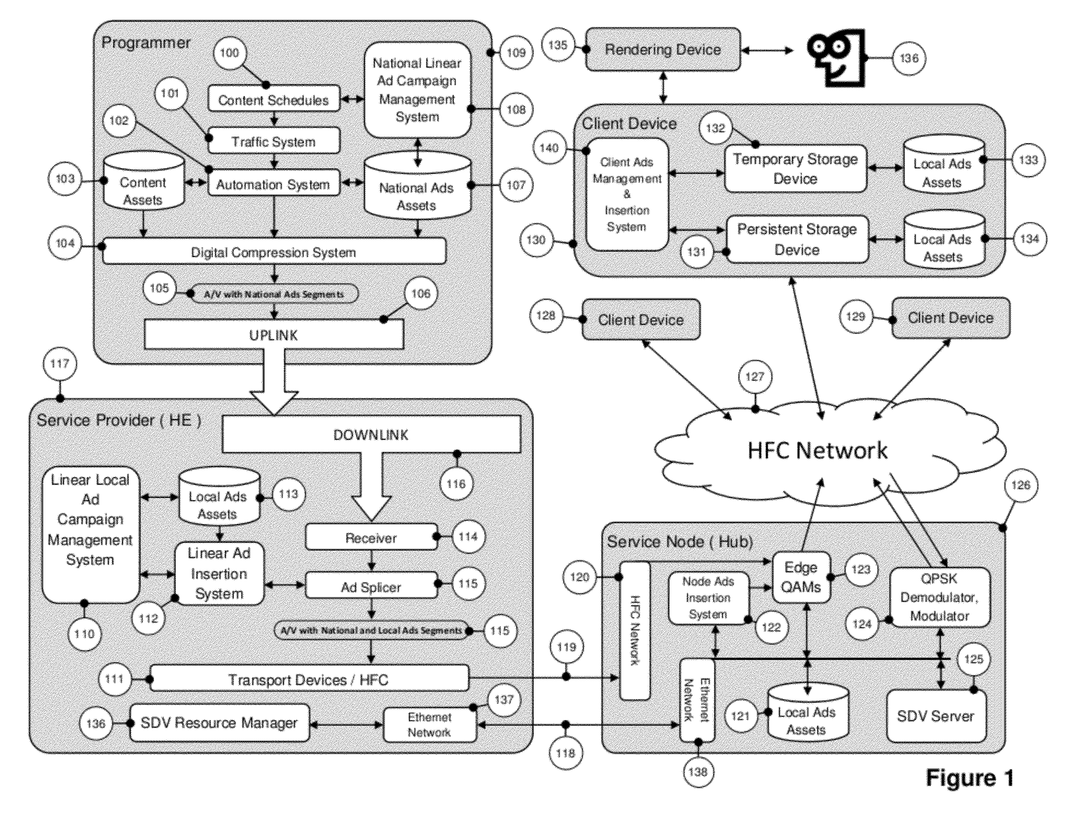

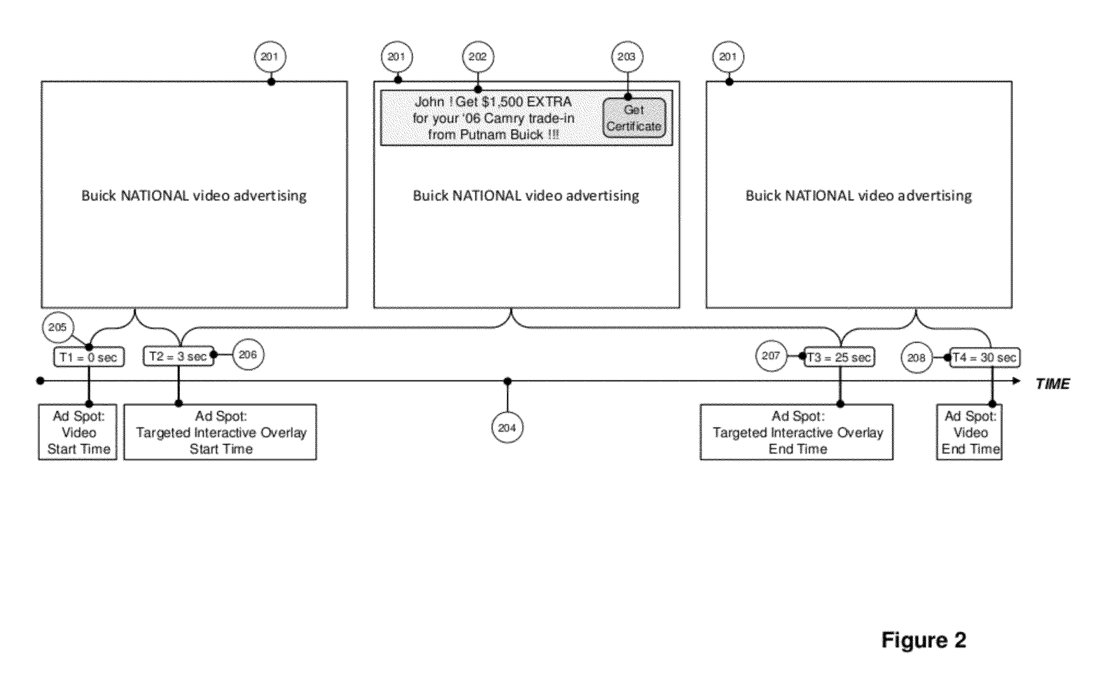

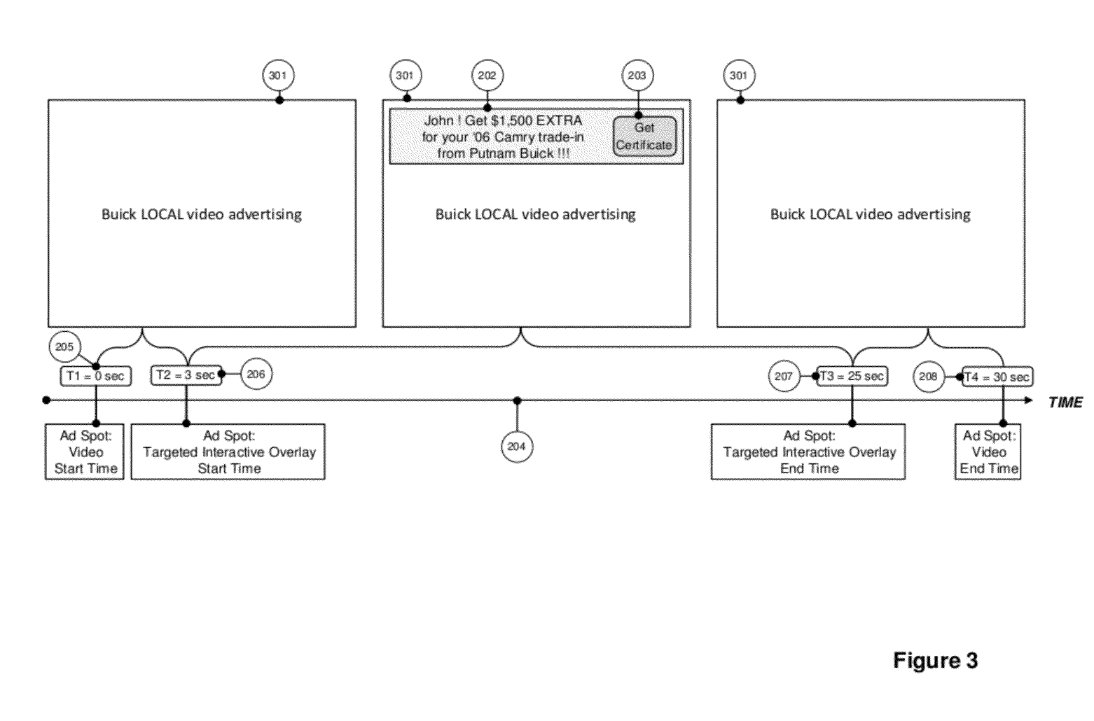

For example, FIG. 1 depicts an embodiment of a video ad insertion of the instant invention. Service provider 117 with linear ad insertion system 112 receives original programmer stream with nationally inserted ads, some of which get replaced by service provider 117 with local ads per content distribution agreements with a programmer. Time slot of one of these replacements is being used in output programming stream 510 to augment national ad spots 512, 514, 516 with corresponding transactional segments 513, 515, 517. The same function can be performed in other network modules such as node ads insertion system 122 in service note 126 and/or client ads management and insertion system 140 in client devices 128, 129, and 130.

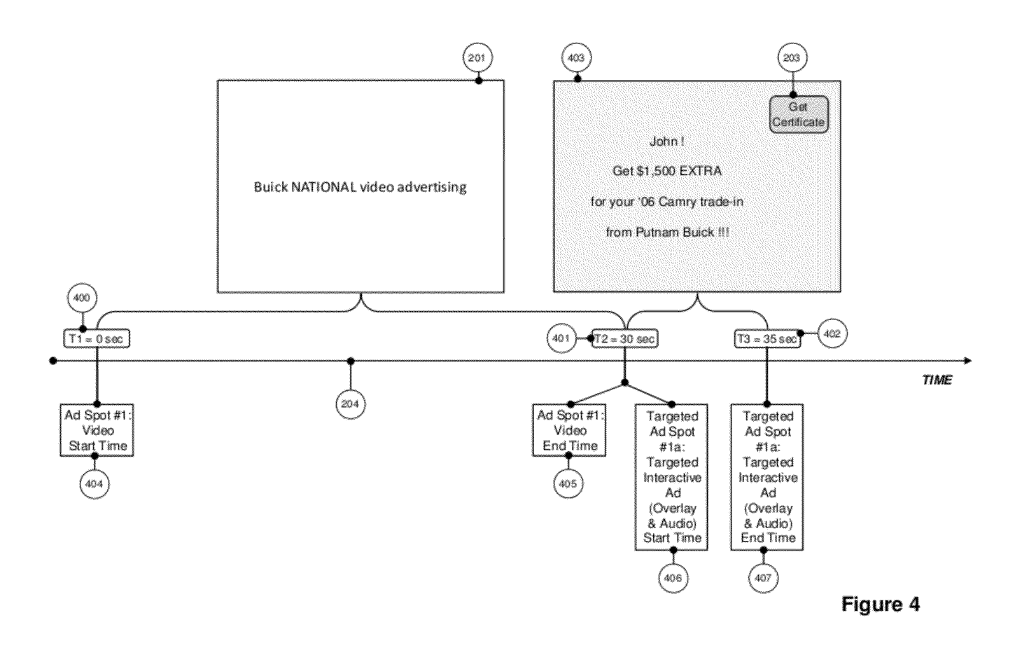

FIG. 4 depicts how the duration of a total video ad (i.e. message 201 plus transactional component 403) is increased to include time for the transactional component. The duration of transactional component 403 can vary from one ad to another, however the duration will preferably be 5, 10, or 15 seconds. At time 400, message 201 starts. Message 201 is fully played and, at time 401, transactional component 403 begins. Transaction component 403 is shown for a predetermined duration, until at time 402 transaction component 403 ends. Preferably, transactional component 403 comprises at least one interactive feature 203 (e.g. a button or a web-link). Transaction component 403 may be targeted to the viewer watching the commercial, as depicted in FIG. 4.

While the length of each commercial is increased, the length of the total commercial break is preferably not increased. Instead, fewer commercials are preferably shown per commercial break. Although the total number of displayed ads is reduced (as a result of such time division), total revenue generated by selling the same (in duration) commercial breaks will increase. The revenue increase is preferably possible because the transaction enabled targeted ads separated in time from the corresponding video ads will command a higher premium when compared to traditional non-transaction enabled ads or transaction enabled ads where the transactional component is overlaid on the original video ad.

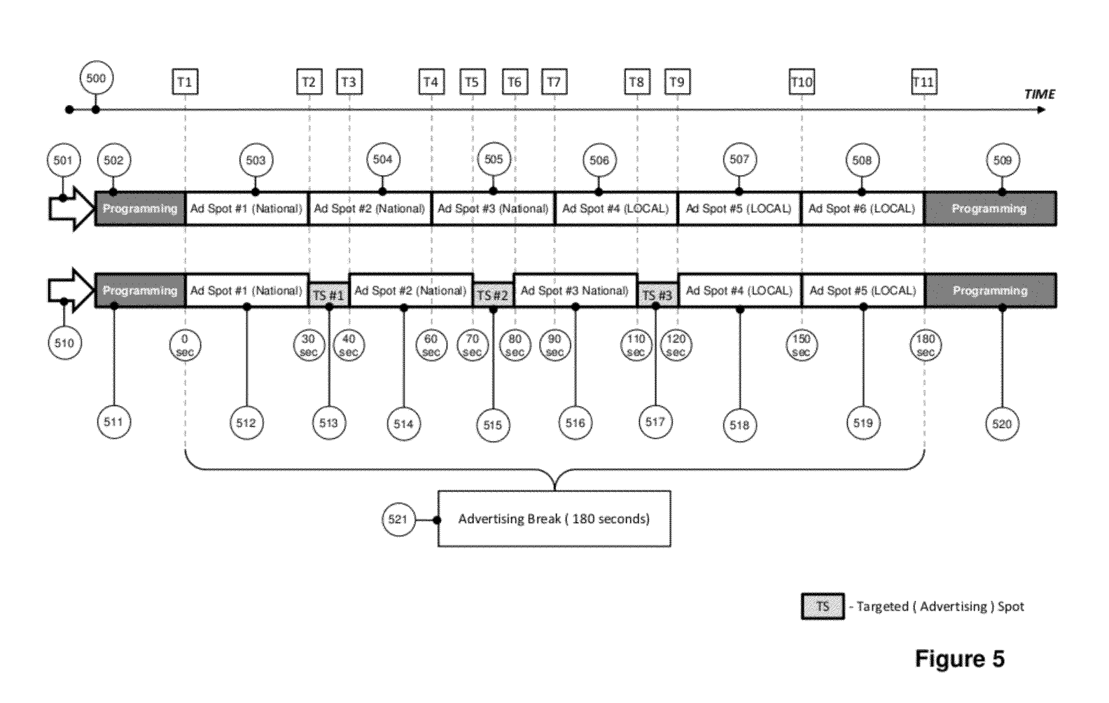

FIG. 5 provides an exemplary comparison of a typical fulfillment 501 of a commercial break 521 compared to an inventive fulfillment 510 for the commercial break 521 having the transaction enabled ads of the instant invention. Within the same 180 seconds advertising break 521, a typical commercial break fulfillment 501 may have six commercials, while there may be five or fewer commercials using the transaction enable ads of the instant invention 510.

For example in commercial break 501, between programming segments 502 and 509, there can be three 30 second national ad spots 503, 504, and 505 and three 30 second local ad spots 506, 507, and 508. However, in commercial break 510, between programming segments 511 and 520, there may be three 30 second national ads 512, 514, and 516, each with a ten second targeted transactional advertisement period following the commercial 513, 515, and 517, and two 30 second local ad spots 518 and 519.

To achieve an unhindered viewer experience (from the beginning a commercial break to an on-time resumption of programming), the video delivery network and ad injection and management system will preferably accommodate the program time shifts caused by the insertion and uneven distribution of ads with extended playback time. The resulting program time shifts can be neutralized by known time shifting methods, such as video buffering (either on a client device or backend ad insertion device).

To achieve full automation of proper and accurate transactional component insertion, the program preferably provides metadata according to existing DPI methodology (e.g. Digital Program Insertion standards: SCTE 30/35/67/118).

While the examples provided herein are for TV viewing systems, the invention is also applicable to other video and audio applications, including, but not limited to, video viewing on PCs, tablets, smart phones, game consoles, radio receivers, MP3 players, and other streaming and linear programming devices.

Although the exemplary environment described herein employs a hard disk database, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A transaction enabled video advertisement, comprising:
a message component having a start time and an end time; and
a transactional component having a start time and an end time, wherein the start time of the transactional component is after the end time of the message component.

2. The transaction enabled video advertisement of claim 1, wherein the transactional component comprises at least one interactive element.

3. The transaction enabled video advertisement of claim 1, wherein the duration of the transactional component is less than the duration of the message component.

4. The transaction enabled video advertisement of claim 1, wherein the transactional component is an advertisement targeted to members of an audience.

5. The transaction enabled video advertisement of claim 1, wherein the advertisement is for display on at least one of a television, a computer, a tablet, a smart phone, a game console, a radio receiver, and a MP3 player.

6. A method of creating a video advertisement, comprising, on a processor:
receiving a message component of the advertisement for presentation during an advertising break in programming;
receiving a transactional component related to the message component;
presenting the message component and the transactional component in separate time slots during the advertising break.

7. The method of claim 6, wherein the transactional component is not overlaid, superimposed, or displayed during the presentation of the message component.

8. The method of claim 6, wherein the transactional component comprises at least one interactive element.

9. The method of claim 6, wherein the duration of the transactional component is less than the duration of the message component.

10. The method of claim 6, wherein the transactional component is an advertisement targeted to members of an audience.

11. The method of claim 6, wherein the advertisement is for display on at least one of a television, a computer, a tablet, a smart phone, a game console, a radio receiver, and a MP3 player.

12. A method of creating a video advertisement, comprising, on a processor:
receiving a transmission of a program having an advertising segment;
inserting a message component of the advertisement into the advertising segment of the program; and
inserting a transactional component into the advertising segment of the program;
wherein the message component and the transactional component are in separate positions within the advertising segment.

13. The method of claim 12, wherein the transactional component is not overlaid, superimposed, or displayed during the presentation of the message component.

14. The method of claim 12, wherein the transactional component comprises at least one interactive element.

15. The method of claim 12, wherein the duration of the transactional component is less than the duration of the message component.

16. The method of claim 12, wherein the transactional component is an advertisement targeted to members of an audience.

17. The method of claim 12, wherein the advertisement is for display on at least one of a television, a computer, a tablet, a smart phone, a game console, a radio receiver, and a MP3 player.
